(19) United States
(12) Patent Application Publication
(10) Pub. No.: US 2020/0043092 A1
(43) Pub. Date: Feb. 6, 2020

(54) SYSTEM AND METHOD FOR OPTIMIZING CAPITAL EFFICIENCY IN MULTI-VENUE TRADING

(71) Applicant: Steven J. Brucato, Holmdel, NJ (US)

(72) Inventor: Steven J. Brucato, Holmdel, NJ (US)

(21) Appl. No.: 16/532,266

(22) Filed: Aug. 5, 2019

Related U.S. Application Data
(60) Provisional application No. 62/714,639, filed on Aug. 3, 2018.
(60) Provisional application No. 62/753,617, filed on Oct. 31, 2018.

(51) Int. Cl. G06Q 40/04; G06F 16/2457

(52) U.S. Cl. CPC G06Q 40/04; G06F 16/24578

(57) ABSTRACT

Computer-implemented systems and methods to manage the allocation of capital resources across multiple trading venues for use in trading multiple types of assets, in order to optimize the use of capital in situations where multiple types of capital are involved. The systems and methods monitor current capital balances across trading venues in real-time, evaluate trade options across eligible venues, select optimal trading venue and form of capital for trade based on maximizing capital efficiency, and optionally rebalance capital after trade completion.

### CROSS REFERENCE TO RELATED APPLICATIONS

This application claims priority from U.S. Provisional Patent Application No. 62/753617 filed on Oct. 31, 2018 and U.S. Provisional Patent Application No. 62/714639 filed on Aug. 3, 2018, and the entire contents of both applications are incorporated herein by reference.

### FIELD OF THE INVENTION

The present invention relates to computer-implemented systems and methods to manage the allocation of capital resources for use in trading multiple types of assets across multiple trading venues, in order to optimize the use of capital in situations where multiple types of capital are involved. The systems and methods of the present invention are particularly advantageous in trading digital assets.

### BACKGROUND OF THE INVENTION

Many electronically tradable products can be traded on several different electronic trading venues, such as exchanges. In most cases, a trader must post some capital with each venue in order to finance their trading on that venue. The capital posted by the trader to secure their trading activity on one venue is generally not shared amongst the different venues, in most cases. Instead, the capital collateralizes trading only on that particular venue. A trader must, therefore, have sufficient capital on each venue on which they plan to trade. Market conditions can vary by venue, so at any point in time a trader may end up being very active on one venue, consuming much of their available capital on that venue, but remain inactive on another leaving the capital on that venue underutilized.

The situation can be further complicated by the fact that various forms of capital may be required on each venue. For example, product denominated in US dollars (USD) may require a capital deposit of a USD denominated assets, while product denominated in other currencies (e.g. EUR or Bitcoin) may require a separate deposit of assets denominated in that currency. In other words, a particular venue supports buying and selling of products in different forms of capital and so a trader may deposit multiple forms of capital onto that venue to collateralize their trading in each of these products. This creates a situation of needing capital of various types to be placed on deposit with such venues. Again, due to varying market conditions, capital of one type (e.g. USD) may be consumed leaving capital of another type (e.g. EUR) underutilized, even on a single venue.

The condition of multiple trading venues, each requiring separate capital to fund trading activity, exacerbated by the complexity of multiple forms of capital, creates the following major problems for traders:
1. High capital needs, due to capitalizing each venue sufficiently to cover large trading needs in active market conditions;
2. Inefficient use of capital due to capital being over utilized on some venues and underutilized on others; and
3. Lost trade profit opportunities due to orders and trades that cannot be completed due to insufficient capital on a particular venue.
   The results of these problems are a lower than optimal return on equity due to the fact that much of the capital on deposit cannot be put to work in earning profits.

The rise in popularity in digital assets has created a rapid increase in the number of trading venues for buying and selling digital assets. A situation resulting in highly fractured liquidity for the digital assets. There are over 200 trading venues to buy and sell digital assets, while the number of digital assets is estimated to have grown to over 2000 products listed in over 10 currencies (forms of capital).

The most popular digital assets, such as Bitcoin (BTC) or Ether (ETH), are listed on most of these exchanges. The price of these products can vary between these venues—and because of these price differences, traders like to trade on multiple different venues. Also, digital assets can be bought or sold with different forms of capital. For example, Bitcoin can be purchased with USD, Ether, USDT (Tether Price Chart Coinbase), USDC (USD cryptocurrency), and several other forms of capital.

Each of these trading venues lists relatively few digital assets to trade (typically less than 300 of the more than 2000 available types of digital assets). Further, the bid/offer sizes (quantity offered) on each of these market exchanges is quite small. In addition, for popular products that are listed on many of these exchanges, significant price differentials can exist among these markets and traders will want to take advantage of significant price differences across markets. Lastly, most tradable products on each exchange are denominated in various currencies, both fiat and cryptocurrency (e.g. USD and Bitcoin).

Thus, digital asset trading hits all the issues that make trading them very capitally inefficient for the following reasons:
A given tradable product is often listed on many venues and price differences between venues mean that traders want to buy and sell on multiple different venues, each venue requiring capital to fund order/trade activity by the trader.
Liquidity is very fractured, split amongst many trading venues with only very small quantities available at the best buy and sell prices on each venue, meaning traders want to trade on multiple venues in order to get the full quantity they wish to buy or sell at the best available prices.
Products can be bought or sold with different forms of capital, meaning the trader must maintain balances in different forms of capital to buy the range of products of interest to them.
Almost all venues require fully funded orders, meaning each order consumes capital even before it trades.
Most venues do not provide leverage, meaning a trader can use only their available capital balance and they do not get credit terms to extend the amount of capital they have available for additional orders.

In summary, the fractured liquidity of digital assets, such as cryptocurrency, is mainly driven by the following factors:
1. Few products listed on each market exchange. To get access to a broad range of products, accounts on many market exchanges are required.
2. Low liquidity on each market exchange. To get a sizable trade for a given product completed, a trader must often place orders for that product on multiple different market exchanges in order to get the cumulative quantity desired.
3. Significant price difference between market exchanges. To find the best price, traders must open accounts on multiple market exchanges or trading venues.
   These factors drive traders to open accounts on many market exchanges. To finance trading on each market exchange, the trader must make capital deposits on each market exchange. Funding accounts on several markets is a significant factor in driving up the capital demands for traders.

A further complicating factor in digital assets is that many products are denominated in multiple different currencies. That is, a given product can be bought with (or sold for) several different forms of capital (several different currencies). For example, Bitcoin may be denominated in USD, Great Britain Pound (GBP), European currency (EUR, Euros), and Ether. The first three are traditional fiat currencies, while Ether is a digital asset or digital currency. The trader is then presented with the problem (and opportunity) of determining which is the best currency to use for his/her order. For example, Bitcoin may be expensive to buy in USD terms, but cheaper to buy in Ether terms—because Bitcoin may have gained more value against the dollar but gained less value against Ether. Traders will often compute the relative value of buying a given digital asset, like Bitcoin, amongst the various currencies in which it is denominated. This means the trader may wish to have USD, Pounds Sterling, Euros, and Ether on deposit with the exchange in order to have buying power in all four currencies to take advantage of relative price differences. Here again, this increases the trader's capital needs.

The vast majority of digital asset exchanges require orders to be fully funded. This means that the trader entering a bid to buy 1 Bitcoin for $6000, must have $6000 available to post the order. The order may or may not trade, but to simply enter the order the trader must have at least $6000 worth of available USD capital in his/her account. This may seem typical to most people, but in trading most mature assets (e.g. US equities, stocks like Apple or IBM), professional traders are able to enter an order without posting the full amount required to complete the trade. This is called trading on margin, or leveraged trading. In short, the trader is being granted a credit line to extend their buying power.

However, in trading of digital assets, the vast majority of exchanges do not offer margin trading and every order must be fully funded. This means the capital requirements of trading on digital asset exchanges is much higher than trading with traditional assets. While there are various reasons that margin is not offered for digital asset trades, including the high volatility of digital assets, the fact remains that margin is not available to the vast majority of traders.

Most financial institutions that provide leverage (credit) services for traders or trading firms will not recognized digital assets as valuable assets on the trader's balance sheet. So, if a trader buys a 1 Bitcoin for $7000, they have given up $7000 in cash but now have a position of 1 Bitcoin. The lending institution will not value the Bitcoin at anything at all (nominal value of $0) so the trader has no value on his/her balance sheet which can be used to secure financing from a lending institution. Contrast this to the case where a trader buys $7000 worth of Apple stock. Most firms will acknowledge of value for the Apple stock now held by the trader—perhaps up to $6000 (depending on the “haircut” in valuation the lending firm applies to the asset of Apple stock). Should this change and lending institutions begin recognizing the value of digital assets on balance sheets, the situation of many small liquidity pools would still demand high use of capital for the reasons described above.

In summary, the capital requirements listed above mean that trading of digital assets is much more capitally intensive than other asset classes.
1. Products listed in several different currencies (forms of capital), which necessitates the deposit of many forms of capital on each venue.
2. No credit terms (margin) offered by exchanges, requiring each order to be fully funded by capital, increasing the capital demands compared to traditional assets
3. Digital assets have no loan value to most lending institutions, meaning credit terms outside of trading venues is extremely limited
   Combining the factors of highly fractured liquidity, unavailability of margin trading, and no balance sheet benefits for borrowing, the capital requirements for trading digital assets are especially large. The additional need for maintaining multiple forms of capital on each market exchange, make the capital requirements for trading digital assets even greater. Thus, compared to more mature financial instruments such as stocks, the capital requirements of trading digital assets are significantly higher.

Another disadvantage is that there are often significant variations in trading activity on one market venue versus another, for a given product. This can happen when the local trader population on a given trade exchange is more active, or driven by news events, that have not yet propagated to other trade exchanges. This will often mean that a trader is actively trading on one exchange more than others. Or that the trader is actively trading with one type of capital more than others. This leaves capital on other exchanges, or capital of other types, underutilized. The combined effect is the trader is not able to bring all of his/her capital into play to finance the desired trading activity. This results in low capital efficiency and the potential for lost trading revenues.

Multi-venue trading within isolated pockets of buying power is therefore a serious issue facing many traders, especially those trading digital assets. It requires a trader to post a much larger amount of capital, thus reducing his/her return on capital. It also constrains the profitability when capital constraints on an active venue are limiting their order activity. There is therefore a need to provide a system that will assist in managing capital and optimizing its use across multiple venues. The invention presented here uses computerized algorithms to significantly mitigate these issues, by comparing prices across venues and in various forms of capital and suggesting optimal trade options nearly instantaneously.

### SUMMARY OF THE INVENTION

Presented here are systems and methods for managing capital efficiency in multi-venue trading that utilize fast computerized-algorithms for trading multiple types of assets across multiple trading venues that maximize capital utilization while managing the complexity of maximizing the use of the most needed type of capital in situations where multiple types of capital are involved. The system will monitor capital balances across venues in real time and when a new order is received (buy or sell order), the system will perform an evaluation of the new buy or sell order. It will compute various values (within the constraints of the parameters provided) and make quantitative decisions using these values to determine both the optimal venue and optimal form of capital to use to achieve the desired order action (which is to buy or sell a product, as per the order instruction from the trader). While the current state of trading digital assets (cryptocurrencies) would benefit significantly from this invention, any trading situation that involves multiple venues and isolated pockets of capital could also benefit.

The algorithmic capital management systems and methods of the invention utilize a fast computerized-algorithm to monitor current capital balances across trading venues in real-time in response to a trade request, calculating, in real time, available capital balances for each type of capital on each of the trading venues based on the trade order; evaluating available options for the trade based on price and capital efficiency, and selecting the optimal trading venue and form of capital to be used for completing the trade order based on calculations designed to optimize capital efficiency and optionally based on parameters set by the trader; transferring asset types between trading venues. The evaluation and selection of the optimal trading venue and form of capital may be accomplished by filtering a list of eligible venues based on the product and the form of capital specified in the trade order, ranking the list of eligible venues of best to worst prices for the product specified in the trade order across all forms of capital; computing expected changes to product and capital balance if the order were to be routed to each of the venues in the eligible list and ranking the list of eligible venues from best to worst in capital efficiency; and selecting an optimal venue and form of capital to use to complete the trade order. Additionally, the systems and methods of the present invention may be constrained by parameters set within the system or by the trader or other user including a pricing priority parameter and/or a rebalancing of capital parameter. The systems and methods of the invention may include the additional steps of predicting near term capital balances on each of the various trading venues and across all types of capital, automatically routing orders to specific trading venues in such a way that use of capital is optimized, and automatically changing the type of capital utilized to accomplish a desired order or trade, and also automatically moving capital across trading venues to manage needs and increase capital efficiency. Further, the trader utilizing the systems and methods of the invention may be a trading venue. For example, a trader who is a dealer may provide bid and offer prices to clients and act as a trading venue. This type of trading is called OTC (over the counter) or dealer trading.

In one embodiment, the present invention provides a computer-implemented method for managing capital efficiency in multi-venue trading in response to a trader submitting a trade order to buy or sell a product in exchange for a form of capital comprising: calculating, in real time, available capital balances for each type of capital on each of the trading venues based on the trade order; filtering a list of eligible venues based on the product availability on each venue; ranking the list of eligible venues of best to worst prices for the product specified in the trade order across all forms of capital; computing expected changes to product and capital balance if the order were to be routed to each of the venues in the eligible list and ranking the list of eligible venues from best to worst in capital efficiency; and selecting an optimal venue and form of capital to use to complete the trade order.

In another embodiment, the present invention provides a computer-readable storage device having contents adapted to cause a programmed computer system comprising one or multiple processor(s), a data storage system, at least one input device, and at least one output system, to perform operations directed to managing capital efficiency in multi-venue trading in response to a trader submitting a trade order to buy or sell a product in exchange for a form of capital, the operations comprising: calculating, in real time, available capital balances for each type of capital on each of the trading venues based on the trade order; filtering a list of eligible venues based on the product availability on each venue; ranking the list of eligible venues of best to worst prices for the product specified in the trade order across all forms of capital; computing expected changes to product and capital balance if the order were to be routed to each of the venues in the eligible list and ranking the list of eligible venues from best to worst in capital efficiency; and selecting a venue and form of capital to use to complete the trade order.

In another embodiment, the present invention provides a computer-implemented method for managing capital efficiency in multi-venue trading in response to a trader submitting a trade order to buy or sell a product in exchange for a form of capital by: calculating, in real time, available capital balances for each type of capital on each of the trading venues based on the trade order; filtering a list of eligible venues based on the product availability on each venue; ranking the list of eligible venues of best to worst prices for the product specified in the trade order across all forms of capital; computing expected changes to product and capital balance if the order were to be routed to each of the venues in the eligible list and ranking the list of eligible venues from best to worst in capital efficiency; and selecting a venue and form of capital to use to complete the trade order, wherein the trader is a venue.

In another embodiment, the present invention provides a computer-readable storage device having contents adapted to cause a programmed computer system comprising of one or multiple processor(s), a data storage system, at least one input device, and at least one output system, to perform operations directed to managing capital efficiency in multi-venue trading in response to a trader submitting a trade order to buy or sell a product in exchange for a form of capital, the operations comprising: calculating, in real time, available capital balances for each type of capital on each of the trading venues based on the trade order; filtering a list of eligible venues based on the product availability on each venue; ranking the list of eligible venues of best to worst prices for the product specified in the trade order across all forms of capital; computing expected changes to product and capital balance if the order were to be routed to each of the venues in the eligible list and ranking the list of eligible venues from best to worst in capital efficiency; and selecting a venue and form of capital to use to complete the trade order, wherein the trader is a venue.

In another embodiment the present invention provides a computer-implemented method for managing capital efficiency in multi-venue trading in response to a trader submitting a trade order to buy or sell a product in exchange for a form of capital by: calculating, in real time, available capital balances for each type of capital on each of the trading venues based on the trade order; estimating future available capital balances for the types of capital on each of the trading venues; selecting the type of capital to be used for completing the trade order; transferring asset types between trading venues; and routing the trading order to one or more trading venues.

In another embodiment, the present invention provides a computer-readable storage device having contents adapted to cause a programmed computer system comprising of one or multiple processor(s), a data storage system, at least one input device, and at least one output system, to perform operations directed to managing capital efficiency in multi-venue trading in response to a trader submitting a trade order to buy or sell a product in exchange for a form of capital, the operations comprising: calculating, in real time, available capital balances for each type of capital on each of the trading venues based on the trade order; estimating future available capital balances for the types of capital on each of the trading venues; selecting the type of capital to be used for completing the trade order; transferring asset types between trading venues; and routing the trading order to one or more trading venues.

The above embodiments may include one or more of the following elements:
venues are identified as eligible if they offer the product selected by the trader;
trade orders are rejected if no venue lists the product specified in the trade order or no venue has sufficient balance capital, preferably in any form of capital, to complete the trade order;
the venue for the trade may be selected based on parameters set by the trader (which in turn may affect the ultimate venue selection as set forth by the algorithm);
the parameters may be selected to maximize capital efficiencies or balance capital efficiencies with price advantages. For example, the best price for the trade may be in one form of capital on one particular exchange, but the optimal capital efficiency may be in another form of capital on a different exchange. The trader provides a parameter, price priority, in order to guide the algorithm in balancing these potentially competing goals. This parameter will allow the algorithm to select one form of capital and one venue for the order.
The trader may also select a base currency such that the system will convert the prices of products to a price in the base currency by means of a conversion factor, thus allowing for comparison of the price of the products across the different forms of capital.
At the request of the trader capital balances at each venue may be rebalanced if a different form of capital is used to complete the order than what was specified in the trade order. For example, a trader may set a capital parameter to automatically rebalance the capital balances after a trade order has been completed.
Orders may be automatically routed to specific trading venues as a result of determinations by the algorithm (SOR)
Type of capital may be automatically changed as a result of determinations by the algorithm
Capital may be automatically moved across trading venues as a result of determinations by the algorithm.

### BRIEF DESCRIPTION OF THE DRAWINGS

FIG. 1 is a flow chart showing the method for managing capital efficiency in multivenue trading by optimizing a trader's capital efficiency, in real time, by filtering and selecting an optimal venue to perform the transaction specified by a trader in a trade order.

FIG. 2 is a flow chart showing the method of managing capital efficiency in multivenue trading by estimating future available balances for the different forms of capital on the different venues, wherein the trade order is completed based on an execution plan which is designed to optimize a trader's capital efficiency.

FIG. 3 is a flow chart for computing realized and available balances of the trader that is submitting the trade order.

FIG. 4 is a flow chart for computation of estimated balances during venue/capital evaluation.

FIG. 5 is a flow chart showing a method for predicting future available balances, a step in the method shown in FIG. 2.

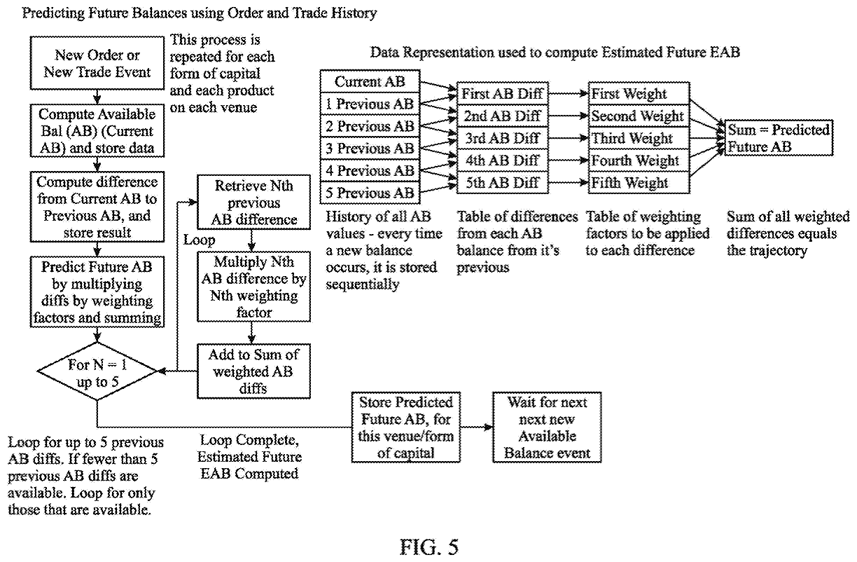

FIG. 6 is a flow chart showing selection of optimal venue and form of capital.

FIG. 7 is a flow chart specifying the method of automated capital transfer to a trader's safe storage account that is repeated for each type of capital and each product on each venue.

### DEFINITIONS AND EXPLANATIONS

Within this document, certain terms are used and for the sake of clarity, they are defined here.

Trading venue, trading exchange, and/or market exchange—A marketplace or platform in which exchange-traded products including securities, commodities, derivatives, and other financial instruments are traded. Examples of trading venues include electronic equity markets, electronic futures markets, OTC trading entities, executing brokers, and broker dealer systems. The present invention is a technology platform or manual process that allows traders to enter buy or sell orders for products that are tradable on that venue. Buy and sell orders are then “matched” in some way, by the venue, to complete a trade. A typical match of a buy and sell order is when a buy and sell order have the same price level indicated. The solution presented here is designed for a trader who trades on two or more trading venues.

Product, Capital, and Currency—A product is the asset that the trader wishes to buy or sell. Products are priced in a particular form of capital, which is usually a currency. A buy or sell order is for a specific quantity of the asset exchanged for a particular amount of capital. For example, buying a share of Apple stock with USD means the product is Apple stock the capital is USD, which is a currency. In certain cases, for example, cryptocurrencies, the product can be both a product and capital. For example, a trader can buy the product Bitcoin with the capital USD. However, a trader can also buy a product Ether with the capital Bitcoin. In this document, the term “product” will be used to refer to the asset that the trader wishes to buy or sell and the term “capital” will be used to refer to the asset that is provided in exchange. Note that a product can also be a currency, or a form of capital. That is, some products are priced in terms of currencies that are themselves also products listed for trading on the same exchange. Thus, the algorithm views product and capital balances both as in fact, they are both ultimately forms of capital that can be used for buying and selling.

Trade—A buy or sell order that completes either partially or completely, resulting in an exchange of value—e.g. capital from the buyer is paid to the seller in exchange for receiving an asset from the seller.

Order—An instruction to buy or sell a product with or for a particular form of capital. For example, a trader can enter an order to buy 1 Bitcoin (the product) for $8000 USD (the capital), or could enter an order to sell 1 Ether (the product) for $800 (the capital).

Price, Best Price—Orders to buy or sell can be placed at various price levels. For example, a buyer can specify the maximum price they are willing to pay—the buy order will trade if a sell order equal to or less than the maximum buy price is entered by a seller. Similarly, a seller can specify the lowest price they will be willing to accept—the sell order will trade if a buy order equal to or higher than the minimum sell price is entered by a buyer. The best buy price for buy orders is the highest maximum buy price offered by any buyer in the market. The best sell price for a sell order is the lowest price offered by any seller in the market.

Product or Asset Liquidity—The available quantity of a product that can be bought or sold. When liquidity is split amongst many trading venues, it is described as fractured liquidity. When each of these trading venues has a relatively small fraction of the sum of all trading venues combined, this aggravates the fractured nature of liquidity (i.e. highly fractured liquidity).

Fully Funded Orders—venues that require fully funded orders will require that the trader have sufficient capital when the order is placed, not only when the trade settles. For example, to place an order to buy one share of Apple for $250 USD, the trader's available balance of USD is reduced by $250 at the time the buy order is placed—even if the order does not trade until much later. Fully funded orders require capital to be allocated to orders before trade settle, and because traders may enter several orders, this can consume much capital. Compare this to a venue that requires capital only at the time the trade settles, which would allow the trader to use more of their capital for orders during a trading period, and then only post the required capital when the trade settles (which might be at the end of the day, for example).

Margin/Leverage—Terms for extending credit. For example, a capital deposit with a value of $1000 may have a credit value of $5000 if the venue is providing 5:1 leverage. This is often referred to as “trading on margin.” Margin and Leverage are used interchangeably in this document. Venues that do not offer leverage require more capital than those that do provide leverage.

Trader/Investor—Used interchangeably to refer to a person or organization that posts capital to secure buying power so that they can enter orders on trading venues and trade on trading venues. Oftentimes, traders focus on one asset in particular, but may trade on any trading venue on which that asset is available to trade.

Buying Power—The ability of a trader to enter an order to buy or sell a particular asset (the term buying power inherently includes selling power), or to complete a buy or sell trade for a particular asset. In all cases, buying power is based on capital kept on deposit with a trading venue or with a third party who is providing credit to the trader. Buying power, in a particular form of capital, is equivalent to the available balance of that form of capital.

Buying power can take many forms. For example, a trader with USD has buying power in USD, but does not have buying power in Euros or Bitcoin. A trader with buying power only in USD cannot pay for something with Bitcoin if he/she has no Bitcoin buying power.

Fiat currency—Money that is not backed by a physical commodity. What drives the value of fiat currency is its scarcity and the fundamentals of supply and demand. It is declared by a central authority, a government, to be legal tender. Therefore, another aspect to fiat valuation is its trust by users.

Cryptocurrency (or crypto currency)—A digital asset designed to work as a medium of exchange that uses strong cryptography to secure financial transactions, control the creation of additional units, and verify the transfer of assets. Cryptocurrencies are a kind of alternative currency and digital currency (of which virtual currency is a subset). Cryptocurrencies use decentralized control as opposed to centralized digital currency and central banking systems. Bitcoin (BTC) and Ether (ETH) are examples of cryptocurrencies.

Virtual Currency—A type of unregulated, digital currency, which is issued and usually controlled by its developers and used and accepted among the members of a specific virtual community.

Digital Asset—a digital representation of a unit of value. Cryptocurrencies are a subset of digital assets. Digital assets can include not only cryptocurrencies, but digital representations of real-world assets such as stocks, commodities, real-estate, or other tangible forms of value such as fine art or collectible automobiles.

Optimal Venue—the optimal venue is the venue that achieves the optimal balance of capital efficiency and price advantages, as determined by the algorithm and the price priorities set by the trader.

Optimal form of Capital—the optimal form of capital is form of capital that achieves the optimal balance of capital efficiency and price advantages, as determined by the algorithm and the price priorities set by the trader.

Triggering Event—An event triggered by the trader (e.g. new order, cancel an existing order) or by the trading venue (e.g. order has traded).

Managing Capital Efficiency—managing a trader's capital across multiple venues such that the trader's goals may be accomplished with efficient use of capital. For example, one of the goals would be to manage the utilization of capital so that the risk of an order or trade rejection due to insufficient capital is minimized while utilizing as much of the available capital as possible. Capital that is not being utilized to fund an order does not have the ability to create a potential positive return (profit). In contrast, a working order can generate a potential profit for the trader when it trades, thus the capital used to fund that order has the ability to generate profit. Similarly, an order that is rejected due to insufficient capital is a missed opportunity for potential profit. The system of the present invention endeavors to utilize any and all forms of capital on any venue, regardless of the trader's original selection of form of capital or venue, to reduce the risk of a rejected order due to insufficient capital. A maximum capital efficiency may be achieved when the system uses all forms of capital on all venues to place as many orders as can be funded (i.e. use any form of capital to provide sufficient capital for the order, regardless of venue or form of capital originally specified by the trader, and regardless of any price disadvantages). An optimal capital efficiency is different from maximum utilization of capital and; for example; may be achieved when the maximum utilization of capital is balanced with price disadvantages (i.e. use any form of capital to provide sufficient capital for the order, regardless of venue or originally specified form of capital, but select only the capital and venue options where the price disadvantage is not too great). The object of the system is to improve ROE (return on equity) by allowing more capital to be utilized for potential profit.

Examples of maximizing capital efficiency or optimizing capital efficiency: A trader wishes to buy Bitcoin. He has entered an order to buy Bitcoin for USD and directed the order to exchange A. The trader has an insufficient USD balance to complete the order on exchange A, so the order is rejected. However, the trader does have sufficient USD balance on exchange B. In this example, the desired order was rejected due to an insufficient balance of capital on one exchange, while leaving the capital on another exchange unutilized, The trader's desired order could have been approved if the order had been routed to exchange B instead of exchange A. The system of the present invention would automatically reroute the order to exchange B (instead of exchange A) because it was aware of the balances on both exchanges. The system of the present invention would thus utilize the capital on exchange B in order to avoid a rejected order. Without the system, capital efficiency would be lower (order rejected thus no potential for profit, unused capital on exchange B with no potential of profit). With the system capital efficiency would be higher (order submitted allowing for potential profit, available capital on exchange B was utilized for potential profit).

A trader wishes to buy Bitcoin. He has entered an order to buy Bitcoin for USD and directed the order to exchange A. The trader has an insufficient USD balance to complete the order on exchange A, so the order is rejected. However, the trader does have sufficient Ether balance on the same exchange. In this example, the desired order would be rejected due to an insufficient balance of one form of capital on the exchange, while leaving another form of capital on the same exchange unutilized. The trader's desired order could be approved if the order capital were changed from USD to Ether. The system of the present invention would automatically change the form of capital from USD to Ether, if the USD-equivalent price difference were not too great, because it would be aware of the balances of all forms of capital on the exchange and would compare the price difference of the asset in both forms of capital. The system of the present invention would thus automatically utilize a different form of capital than the form originally specified by the trader,in order to get the order approved. Thus, the system would increase capital efficiency (order is submitted allowing for profit, available capital on exchange A was utilized for potential profit).

A trader wishes to buy Bitcoin. He has entered an order to buy Bitcoin for USD and directed the order to exchange A. The trader has a sufficient, but just barely enough, balance of USD on exchange A. This means the order will not be rejected but the very low remaining balance of USD on exchange A increases the likelihood of a future successive USD orders being rejected for insufficient USD balance. The trader has a much higher USD balance on exchange B than on exchange A. The system of the present invention would route the order to exchange B instead of exchange A, assuming the price disadvantage on exchange B compared to the price on exchange A were not too extreme. This would increase the likelihood that successive orders to either exchange will have sufficient capital to be approved. This would consequently increase the likelihood that the system, or the trader, can select either exchange A or exchange B as a viable venue for successive orders as both are more likely to have sufficient capital for successive orders. Capital efficiency is thus increased for successive orders, because larger balances on both exchanges allow for greater options in selecting the exchange with the better price at the tine of the trader's next order placement.

The above examples are just an illustration of how the system may be used to manage capital so as to optimize efficiency. There are other parameters a trader nay use to align capital availability with the trader's goals.

### DETAILED DESCRIPTION OF THE INVENTION

Although the invention in this application is described with reference to specific embodiments, the invention is not limited to the embodiments and the specific configurations shown in the drawings. For example, components, regardless of which embodiment they appear may be combined with each other as another embodiment, and/or a component can be divided into several subcomponents, and/or any other known or available component can be added. The operation processes are also not limited to those shown in the examples. Those skilled in the art will appreciate that the invention can be implemented in other ways without departing from the substantive features of the invention. For example, features and embodiments described can be combined with and without each other. The present embodiments are therefore to be considered in all respects as illustrative and not restrictive. Other embodiments can be utilized and derived therefrom, such that structural and logical substitutions and changes can be made without departing from the scope of this disclosure. This specification, therefore, is not to be taken in a limiting sense, along with the full range of equivalents to which such claims are entitled.

The solutions presented here require fast, electronically computed algorithmic solutions that are intended to increase the efficiency of capital by quickly computing several important factors before or immediately at the time a new order is entered, thereby reducing the gross amount of capital that the trader must deploy to each exchange. The invention will now be described in detail with reference to the exemplary embodiments and examples below and the Figures.

The system and methods of the invention are computer-implemented in a computing-implemented storage device environment allowing for real time processing of orders. Some aspects of the technology may be described herein in general context of computer-executable instructions, such as routines (algorithms) executed by a general data processing device (as for example one or multiple server(s) or client computers). Facets of the technology described may be stored or distributed on computer-readable media, including magnetically and/or optically readable computer discs, hard- wired and/or preprogrammed chips, diverse technologies of memory, or other data storage media. Alternatively, server or computer-implemented instructions, data structures, monitor displays, other data related to the technology may be distributed over other networks and/or via the Internet or via wireless networks on a propagated signal. In some implementations, the data may be provided on any analog or any digital network.

The described technology can as well be run and executed in distributed ledger and distributed computing environments, where tasks or modules are performed by remote processing devices, which are linked through a network, such as a LAN (Local Area Network), WAN (Wide Area Network) or via the Internet.

In a distributed computing environment, program modules or subroutines may be located in local or remote memory storage devices or a combination thereof. Parts of the technology may reside on a server, while corresponding parts may reside on a client computer (e.g., personal computer, mobile laptop computer, ipad or tablet, smart phone, smart watch, etc.). Data structures and data transmission of particular facets of the technology are enfolded within the scope of the technology.

The computer-readable storage device may be implemented on a computer, such as a server, personal computer, workstation, phone, smart phone, iPad or tablet, or smart watch having one or more processors coupled to one or more user input devices, data storage devices. The computer is also coupled to at least one output device, such as a display device, and one or more optional additional output devices (printer, diverse output devices, etc.). The computer may be coupled to external computers, such as via a network connection, and/or wireless transceiver, or both or multiple of these. E.g. network hubs, switches, routers, or different hardware network components within the network connection and/or wireless transceiver can couple one or more computers/desktops and/or servers. The input devices may include a keyboard and a mouse or input pad. Other input devices are as well possible, such as a microphone, scanner, digital camera, video camera, and the like. A machine to machine input option is also possible. The data storage devices may include any type of computer-readable media that can store data accessible by the computer, such as diverse magnetic hard and floppy disk drives, optical disk drives, flash memory cards, digital video disks, RAMs, ROMs, smart cards, etc. Any medium for storing or transmitting computer-readable instructions and data may be used, including a port connection or network node, as e.g. LAN, WAN, or the Internet.

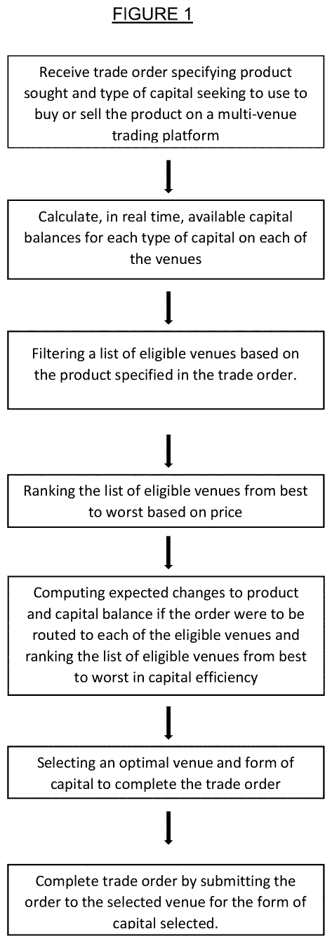

In one embodiment (see FIG. 1), the system and method of the present invention comprises the following elements:
1. Monitoring Capital Balances in Real-Time, across all venues, for all types of capital. The algorithmic computations below require the quantification or calculation of the capital balances of each type of capital deposited with each trading venue. An order, a deposit, or a withdrawal performed by the trader will change the available capital balance for a particular form of capital on a particular venue. For example, entering an order to buy 1 Bitcoin for $8000 on exchange A where the trader has a capital balance of $16,000 will leave the trader with an available balance of $8000 on exchange A.
2. Filtering the List of Eligible Venues. When the system receives a new order, it examines the product specified in the order. The system will select the list of eligible venues from the list of all available venues as those that list the product specified in the trader's order. If no such venues meet the criteria, the order is rejected and the system awaits the next order.
3. Ranking Prices across Venues and Form of Capital. For the filtered list of venues selected above, the system will rank the prices from best to worse across the venues. If the product is listed with another form of capital on a venue, the system will convert all prices into a common form of capital using a conversion factor, then create a ranked list of best to worst prices for the product across all forms of capital.
4. Computing Expected Balance Changes and Ranking by Capital Efficiency. The system will compute the expected change to product and capital balance if the order were to be routed to each of the venues in the eligible list. This will result in a list of expected balances for each capital and product on each venue. Venue/capital combinations that results in negative expected balances will be removed from the eligibility list. The system will evaluate the current and expected balances for each venue and rank the venues in terms of capital efficiency.
5. Selecting the Optimal Venue and Form of Capital. The system will then select the venue and form of capital to use to complete the trader's order. The venue and form of capital will be the one that is determined by the system to be optimal for the trade based on the algorithm and on optional parameters set by the trader that inform the algorithm so as to the trader's constraints. The trader may choose to select the venue/capital that maximizes capital efficiencies, or may elect to balance capital efficiencies with price advantages. Often times, a trader will want to balance a better price with other potentially competing goals such as capital efficiency. Thus, the system allows for the trader to express their goals balance.
6. Optional Step: Rebalancing Capital. If the system uses a different form of capital than was originally specified in the order, the trader may ask the system to rebalance the capital balances to be equivalent to the original form of capital being used. If rebalance capital parameter is set, the system will execute a second order automatically to rebalance the capital balances.

Each of these elements is discussed in more detail below. Each of these elements is computer-implemented for essentially immediate real time processing of orders using algorithms known in the art.

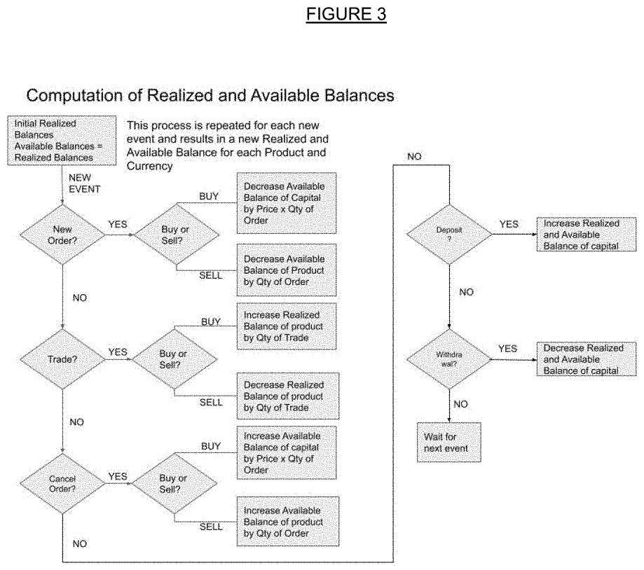

Monitoring Capital Balances in Real Time (see also FIG. 3 and Example 1): Balances must be measured in real-time, at each exchange for each type of capital and for each product. The balance of each form of capital and each product, on each venue, must be measured. It is important to measure both balances of capital and product as both can be consumed or generated in trading, and so in many ways both products and capital are equivalent.

Each order, each trade, each canceled order, each cancel/replace order, each deposit, each withdrawal, and generally any action taken on a trading venue will affect the amount of available capital or product. Events that affect capital balances can be triggered by the trader (e.g. new order, cancel an existing order) or events can be triggered by the venue (e.g. order has traded, or was canceled by the exchange). The system computes balance upon each trigger event to have the balance ready for decisions to made later by the system.

It is critical that the balances be kept up to date as quickly after a trigger event as possible so that system decisions, such as venue routing or alternate currency decisions, can be made with the most accurate balance data at the instant a new order from a trader is received. The balance monitoring process is a continuous process that monitors for any events that will alter capital balances. The purpose of this process is to provide the decision-making components of the system with the most up to date balance information.

A computerized system optimized for rapid event-based computation is important to allow the system implementation to function as required to achieve capital efficiencies. At least two different types of capital balances will be measured, for each form of capital on each venue;
1. Realized Balances—these are the balances for each type of capital or product in absolute terms, irrespective of any working order. Realized balances generally result only from deposits, withdrawals, and completed trades. Realized balances are not changed by any order events (including submitting new orders, canceling orders, etc). Table 1 in Example 1 outlines some actions and the resulting effect on Realized Balances of buying power;
2. Available Balances—this is the balance available to the trader for buying and selling and for entering new orders. The Available Balance consists of Realized Balance adjusted by the capital needs of any working orders to compute the “worst case” (lowest) Available Balance. The “worst case” Available Balance is the computed by subtracting the capital cost of each new order at the time the order is entered, but not showing the additive benefit of the order trading until the order actually trades. Thus, the trader's balance is reduced by the amount he/she must pay if the order trades, at the time the order is entered, but the trader is not credited with the received asset of the order until the order actually trades. Working orders my “rest” on the market for some time before trading, during this time only the “payment” part of the order is subtracted from the Available Balance. Because trading of digital assets is fully funded (no margin), a trader must have sufficient Available Balance in order to place an order, but will not receive the receive benefit of that order until it trades.

Filtering the List of Eligible Venues: When a new order is received (buy or sell order), the system will perform an evaluation of the new buy or sell order and based on any parameters set by the trader will generate a list of possible venues. It will compute various values (within the constraints of the parameters provided) and make quantitative decisions using these values to determine both the optimal venue and optimal form of capital to use to achieve the desired order action (which is to buy or sell a product, as per the order instruction from the trader).

It is important to understand that many of these procedures use current prices available for a given product, and that these prices can change very quickly—multiple times per second. It is therefore critical that these instructions be executed very quickly in a computer algorithm.

The system will then go on to filter the list of eligible venues to those that support the product referenced in the original order instruction from the trader. For example, an order to buy Bitcoin for USD will result in a list of venues that support the trading of Bitcoin in USD or any other form of capital, such as Ether. Venues that do not support the trading of Bitcoin in any form of capital will be excluded. Similarly, venues with and insufficient balance of capital, for any form of capital, will be excluded from the list. If no venue supports the product specified in the order, or if no venue has a sufficient balance of capital (of any form) to complete the order, the order is rejected back to the trader with an explanatory message and the system awaits the next order. This is unlikely as the trader is aware of the tradable products and available balances of capital on each venue. An optional embodiment of this algorithm will allow the use of several forms of capital to fulfill a single order. For example, assume a trader enters an order to buy Bitcoin with USD, and the trader has balances in both USD and Ether both of which can be used to buy Bitcoin, but the trader has an insufficient balance of both USD and Ether to complete the order. However, the combined balance of Ether and USD can be used to complete the order. In this embodiment, the algorithm will create 2 orders to complete the trader's buy order—one order to buy some Bitcoin with USD, and another to buy Bitcoin with Ether. In this embodiment, venues with insufficient balance in any one form of capital are not excluded from the list of venues.

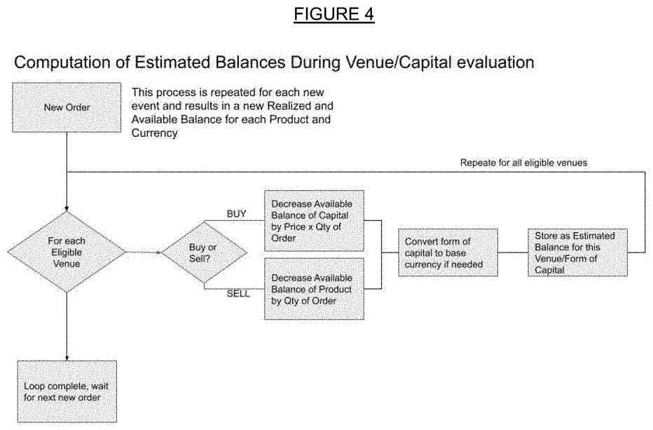

Ranking Prices Across Venues and Form of Capital (see FIG. 4 and Example 2): For the filtered list of venues created above, the system will compare the price differences of the product across these venues, and across alternate forms of capital within these venues, and rank the prices from best to worst. The product/capital pair selected in the original order may be listed on more than one trading venue, and the best price across those venues can vary. Additionally, the product which the trader wishes to buy or sell may be able to be bought with or sold for a different form of capital from the form in the original order instruction. These alternate forms of capital for the same product may be available on one or more than one venue. The system will identify the venues on which the original product/capital pair is listed. Similarly, the system will identify the venues on which the product is available in other forms of capital, then convert those prices to the form of capital in the original order. This list of prices for the product, across various venues and various forms of capital, now in terms of a common capital, will be ranked from best to worst price.

Computing Expected Balances Changes and Ranking by Capital Efficiency (see Example 3): Next, the system will then compute the expected change to product and capital balance if the order were to be routed to each of the venues in the eligible list, for any form of capital (as the list may contain the product priced in forms of capital different from the form originally specified by the trader). This will result in a list of expected balances for each capital and product on each venue. Any form of capital that results in a negative expected balance will removed from the eligibility list, as there is insufficient balance of that form of capital to complete the order. The system will then rank the venues in terms of capital efficiency. Venue capital efficiency is determined by measuring the absolute value of the maximum difference in capital and product balances, across all venues, assuming the order is routed to each venue respectively, and converting all forms of capital into a common form for comparison. The common form of capital used for conversion will be the form of capital originally specified in the order from the trader. The venue that results in the smallest difference in capital balances is the highest rank in terms of capital efficiency because the goal of the algorithm to achieve a consistent balance across all venues.

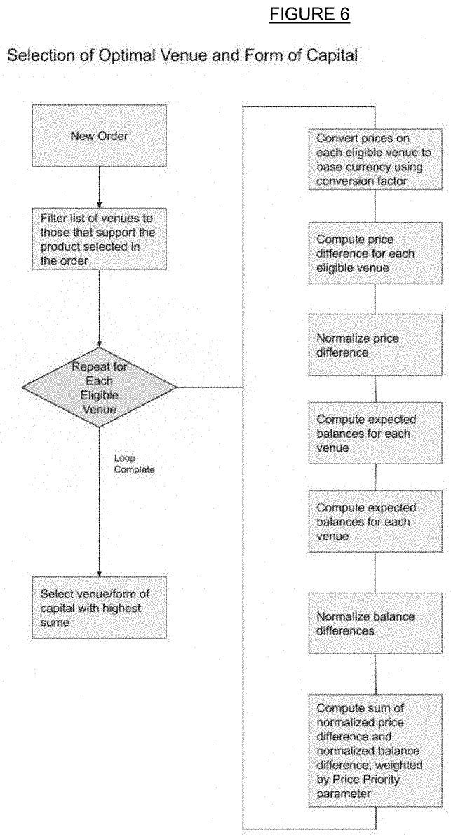

Selecting the Optimal Venue and Form of Capital (see FIG. 6 and Example 4): Finally, the system will select the optimal form of capital and the optimal venue for the order to in order to achieve the trader's goals. The trader can establish the goal as maximum capital efficiency only, maximum price benefit only, or a combination of these goals which may or may not be in competition with each other (i.e. may select different venues or forms of capital). To achieve the desired goals of the trader, the systems and methods described herein may be constrained by “parameters” set by the trader. As this buying or selling of products is a very price-sensitive activity, the trader may wish to balance the value of achieving a better trade price with the value of maintaining optimal capital efficiency. Alternatively, the trader may wish to prioritize only price benefits, or only capital benefits alone. To balance these two goals, which may be competing goals, the trader will set a parameter to inform the system how to achieve the trader's desired balance of goals.

For example, the trader may set up a “Pricing Priority Parameter.” A pricing priority parameter can be set by the trader to guide the algorithm to seek the optimal balance of price and capital benefits. This factor could be set from 0 to 100. A value of 100 means prioritize price completely and ignore all capital benefits. A value of 0 means ignore all price benefits and prioritize only capital benefits. A factor between 0 and 100 will be a balance of the two, potentially competing, goals. An example of the application of this parameter is shown in the examples below.

At this point, the system has established the venue rankings for price benefit and for capital efficiency according to the trader's goals.

Optional Step: Rebalancing Capital: The trader may choose to enable a Rebalance Capital parameter, which, upon use of a form of capital different from the trader's original order, then the system will automatically execute a second trade to bring these two forms of capital to the same balances as if the original form of capital was used.

Because the system may choose a different form of capital to complete the trader's order, the trader may wish for the system to automatically enter an order to achieve capital balances as if the originally intended form of capital, as originally specified in the trader's order, were used. This parameter can be set to on or off.

Continuing with the above example, assume the trader set the Pricing Priority Parameter such that Exchange C and Ether were used to complete the trader's order. The trader wants to buy Bitcoin with USD, but the system buys Bitcoin with Ether. This means the trader will have an unexpectedly lower balance of Ether and an unexpectedly higher balance of USD. Now the trader may wish to keep this situation because the system has calculated that overall, across all venues and forms of capital, this is best overall balance of capital. However, the trader may nevertheless wish to balance this out—reduce the USD balance and increase the Ether balance as if the order were originally executed exactly as entered (e.g. Buy 1 Bitcoin for $8100).

Different Capital Balances across Venues: In the system described above, the goal of the system is to achieve as nearly identical balances of capital across all venues for all forms of capital. However, it is possible to change these goals to favor higher balances of certain forms of capital on select venues, and lower balances on others. In other words, a purposeful unequal distribution of capital across the venues. This may be beneficial if one venue has higher liquidity than the others, or consistently better pricing than the others. In such cases, that venue may be more heavily traded and thus require consistently higher capital balances than the other venues. It is also possible to dynamically adjust capital balance targets across venues based on historical prices or trading volumes.

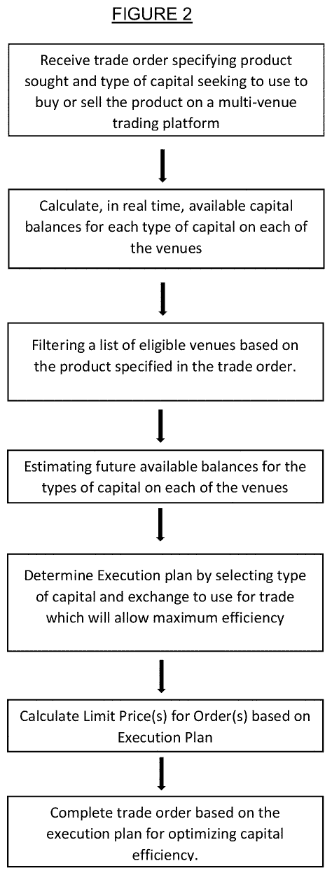

Although the system and method of the present invention can work effectively based on actual available balances, its utility may be increased if an estimate of available balances in the near future is available. There are many algorithmic approaches to estimating values in sequential numeric data, and most any of these can be applied to this predictive challenge. Thus, in another embodiment of the present invention (see FIG. 2), in addition to measuring the balance of capital and products across each venue as events occur, a projection may be used to estimate these balances in the near future based on orders and trades that have been entered recently. predict future capital balances, seconds or minutes in the future, based on recent order and trade activity.

Predictive estimates, based on recent order and trade activity and analysis of market data, can provide an estimate of the capital balances in the near future (seconds or minutes into the future). This would allow the algorithmic capital management system and method to act more dynamically and respond to varying conditions automatically. For example, if there are many orders to buy Bitcoin with USD, then the system could detect this trend and project balances of Bitcoin that are higher and balances of USD dollar that are lower before these balances are changed appreciably. In this case, the system compares the expected or predicted available balances or a combination thereof to obtain the most equal distribution of capital among the trader's venues or a distribution target selected by the trader or the algorithm based upon events or overall activity.

In another embodiment of the present invention, the selection of the optimal venue and form of capital may be made by focusing on the type of capital to use for a given order in order to maximize the efficient use of capital. If a trader has capital balances in both USD and ETH, and enters an order to buy Bitcoin with USD, and the algorithm detects that USD capital balances are low or are predicted to be low, the algorithm will seek to determine if the trader has more capital available in another form, such as ETH. If so, even if the price is slightly worse in ETH than USD, the algorithm will decide if capital advantage outweighs the price disadvantage and change the order to buy Bitcoin in ETH instead of USD.

If the product is denominated in multiple currencies, choice of the currency used can help optimize capital efficiency. For example, if the product Ether can be purchased with either Bitcoin or USD as currencies, the choice of using Bitcoin or USD can be made in such a way to optimize capital efficiency. If the trader has a much higher Bitcoin balance than USD, it is more beneficial to use Bitcoin as the currency over USD. However, because relative values of these two currencies can affect the economics of the trade, the decision to use one currency over another must also consider the economics of the trade. For example, Ether may be quite expensive in terms of Bitcoin, but quite cheap in terms of USD if the value of Bitcoin is (at the moment) very low when compared against the US Dollar. This will create a price difference in the product listed in one currency versus another. Thus, it is advantageous to evaluate the economic value of the price difference. To make this comparison, the trader will select a base currency for price comparisons. This is typically the home currency in which the trader settles his/her trades. Prices of products in one currency can be converted to the price in the base currency by means of a conversion factor. This conversion factor can be computed from the exchanges as an implied value. By converting the price of the product in each currency back to a single base currency, the relative value of the two prices can now be compared.

The capital efficiency may also be determined as described above. If the price comparison indicates the product is a better value in the same currency as the calculated optimal currency for capital efficiency, then the order should be changed to the new optimal currency for capital efficiency because it is both a better price and optimizes capital efficiency. However, if the optimal price currency is different from the optimal capital efficiency currency, the two must be competing goals must be resolved into a single decision. To do this, price priority, will be assessed. The price priority parameter allows the algorithm to decide how much weight to give price advantages over capital efficiencies. The use of this parameter, which is set by the trader, allows the algorithm to combine competing goals of price advantages and capital efficiencies into a final decision on venue selection and the form of capital.

Advantageously, the algorithm of the present invention can be used as a Smart Order Routing for Optimal Capital Efficiency tool. In electronic trading, the term Smart Order Routing (SOR) is used to refer to a decision-making process to decide which trading venue (exchange) to route a particular order to. It applies to situations where a given order, for a given product denominated in a given currency, is listed on multiple venues so there are several options for where to send this order. This decision is made by an algorithm and is intended to achieve a particular trading goal. For example, SOR algorithms used in electronic trading include route to market with the best trade price, route to market with the most liquidity, etc.

The method of the present invention involves a novel SOR algorithm—routing to the product/capital pair on a particular exchange that will present the best combination of price advantages and capital efficiency. This may include routing an order to an exchange where the trader has more available capital of the correct type, even if the price is slightly worse than the exchange where the trader has less capital available. To be effective, this computation must be done in real-time. For example, monitoring of capital balances in real-time and estimated near-term future capital balances discussed above are used to selectively route new orders to specific trading venues to maximize capital efficiency. In one embodiment described above, the novel SOR algorithm can be used to route orders based on evaluating the impact the order will have on Available Capital Balances on each exchange, and will route the order to the exchange that provides maximum capital efficiency.

For example, thee product may have a pricing advantage on one exchange versus another. If the exchange that provides the greatest capital efficiencies is the same as the one that provides the best price, the decision is to route the order to that exchange. However, if the exchange with the better price is different from the exchange that offers the greatest capital efficiency, then the relative magnitude of these two factors on the economics of the trade must be analyzed. This process was described previously, and the same process is used here.

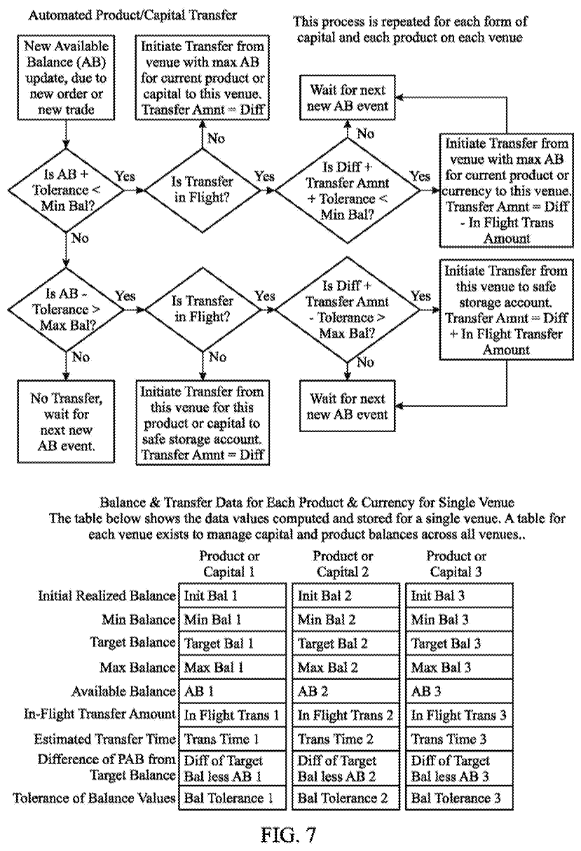

Optionally the system and method of the present invention may have the option of automatically moving capital between exchange venues (see FIG. 7). Many exchanges allow for the programmatic transfer of capital, especially digital asset capital types. This option could be used to automatically rebalance the capital throughout the venues. In addition, the option could be used when predicted capital balances are expected to be too low at one exchange and less utilized at another. In this case, with the information provided by the predictive algorithms described above, an event may be triggered to programmatically move the capital before a shortage of buying power occurs. For example, if the algorithm predicts buying powers below a certain threshold for a particular type of capital (fiat or digital), it will trigger capital movements from a trading venue with a predicted surplus to the one with a predicted shortage, if a venue exists with a predicted surplus. If not, no transfer is performed.

The capital movements can be done programmatically, where banks and venues provide programmatic interfaces for withdrawals and deposits, or can be processed manually if the algorithms alert operational staff to initiate a move of a specific type of collateral, how much, from, and to a specific venue. One advantages of digital assets is that they can be moved much more quickly than traditional fiat currencies. Transfer of digital assets can occur in minutes whereas fiat transfers will take hours or even days. Because of this, digital assets as capital, which are often used as the currency in which a product is denominated, present a unique opportunity for rapid transfer of capital between venues to achieve optimal capital efficiency.

The algorithmic capital management systems and methods of the present invention may also be adapted to the needs of a trader that is also a trading venue (firm). Such traders are called dealers and this type of trading is called OTC (over the counter) or principal trading. It differs from venue (exchange) trading as there is no venue that aggregates orders from various traders, instead a trade occurs between one trader (i.e. the client) and another trader (i.e. the dealer), with one of them (dealer) providing bid and offer prices to the other (client). The dealer will often trade on multiple venues, trading exchanges and/or market exchanges, to “hedge” the traded positions they have achieved when trading with clients. Hedging reduces the risk of price changes in the assets that the dealer is holding based on its trading with clients. In this scenario, the dealer is trading on multiple venues to hedge but is also providing quote prices for clients who are trading with the dealer.

The orders from the dealers to two or more venues can be managed by the same algorithm described above. However, because the dealer is providing the bid and offer prices, this gives the dealer another parameter to adjust their capital—that is, the dealer can adjust the prices presented to clients to incentivize clients to buy or sell products in such a way to optimize the capital positions of the dealer. For example, assume the dealer has many clients that wanted to buy Bitcoin with USD. The dealer will attain a high balance of USD and will attain a low balance of Bitcoin. The dealer may then offer very high prices for buying Bitcoin with USD, thus discouraging clients from buying Bitcoin from him with USD, but also offer very high prices to buy Bitcoin from clients, thus encouraging clients to sell their Bitcoin to the dealer in exchange for USD. The capital balances can be managed, to some degree, by adjusting the prices of products (which are capital) priced in a particular form of another capital. To continue with the above example, if the dealer has very high balances of Ether (in additional to the high balances of Bitcoin and the low balances of US Dollar), the dealer may price bitcoin purchases (Bitcoin offer) prices in Ether at very unattractive prices, because the dealer does not want to increase their balance of Ether when selling Bitcoin. The amount of pricing advantage or disadvantage in and product/capital price presented by the dealer to clients will vary proportionately to the degree of expected balance change of the product or capital. This means the dealer will provide better prices one side (buy or sell) and worse prices on the other side (sell or buy).

### EXAMPLES

### Example 1

### Realized and Available Capital Computation

Table 1 provides examples of trade mediated actions on realized and available balances at a single trading venue.

TABLE I

| Action | Realized Balance | Available Balance |
|---|---|---|
| Trader makes initial | USD: $1000 | USD: $1000 |
| deposit of $1000 to open | | |
| an new account | | |
| Trader make an | USD: $7500* | USD: $7500* |
| additional deposit of | *deposits affect realized | *deposits affect available |
| $6500 | balance immediately | balance immediately (once |
| | (once confirmed) | confirmed) |
| Trader make a deposit of | USD: $7500 | USD: $7500 |
| 1 Bitcoin | Bitcoin: 1* | Bitcoin: 1* |
| | *deposits affect realized | *deposits affect realized |
| | balance immediately | balance immediately (once |
| | (once confirmed) | confirmed) |
| Trader submits order to | USD: $7500 | USD: $1000 |
| buy 1 Bitcoin for $6500 | Bitcoin: 1* | Bitcoin: 1* |
| but order has not traded | *realized balance is 1 | *available balance is 1 |
| yet | because buy order has | because buy order has not |
| | not traded yet | traded yet |
| Trader order trades | USD: $1000 | USD: $1000 |
| | Bitcoin: 2 | Bitcoin: 2 |
| | *realized balance is | |
| | affected immediately by | |
| | trades | |
| Trader submits order to | USD: $1000 | USD: $1000 |
| sell 1 Bitcoin for $7000 | Bitcoin: 2 | Bitcoin: 1* |
| but order has not traded | | *available balance is 1 |
| yet | | because client must set aside 1 |
| | | Bitcoin (of the available 2) in |
| | | case this order trades |
| Trader submits order to | USD: $1000 | USD: $700* |
| buy one Ethereum for | Bitcoin: 2 | Bitcoin: 1 |
| $300 but order has not | Ether: 0** | Ether: 0** |
| traded yet | **balance is 0 because | *available balance is reduced |
| | buy order has not traded | by $300 to set aside funds |
| | yet | needed in case order trades |
| | | **balance is 0 because buy |
| | | order has not traded yet |
| Trader submits order to | No change - buy order | No change - buy order rejected |
| buy one Bitcoin from | rejected due to Available | due to Available Balance of |
| $6500, working orders | Balance of USD <$6500 | USD <$6500 |
| have not traded yet | | |
| Trader sell Bitcoin order | USD: $8000 | USD: $7700 |
| trades (sell 1 Bitcoin for | Bitcoin: 1* | Bitcoin: 1 |
| $7000) | Ether: 0 | Ether: 0 |
| | *now that sell order has | |
| | traded, realized balance | |
| | is reduced | |
| Trader buy Ethereum | USD: $8000 | USD: $8000* |
| order is canceled by | Bitcoin: 1 | Bitcoin: 1 |
| client | Ether: 0 | Ether: 0 |
| | | *the $300 deducted from |
| | | available balance is now |
| | | returned because buy order |
| | | was canceled |

### Example 2

### Rank Prices for the Product across Venues and Forms of Capital

A trader wishes to buy 1 Bitcoin for a price of $8100—meaning that the purchase price can be $8100 or lower (Table 2). Bitcoin/USD is offered on 2 exchanges, and Bitcoin is available for a different form of capital, Ether, on a third exchange. In this example, we will use fourth exchange to compute the Ether to USD price conversion.

TABLE 2

| | Exchange A | Exchange B | Exchange C | Exchange D |
|---|---|---|---|---|
| Product/Capital | Bitcoin/ | Bitcoin/ | Bitcoin/ | Ether/USD |
| Pair | USD | USD | Ether | |
| Best Sell Price | $8010 | $7800 | 9.8 | $800 |
| Convert all | $8010 | $7800 | $7840 | $800 |
| Prices to USD | | | | |
| Price difference | +2.69% | 0% | +0.51% | n/a |
| from best price | | | | |
| Price Rank | 3 | 1 | 2 | n/a |

To convert product prices from one form of capital to another;
Price in Capital A=Price is Capital B times Conversion Factor of B to A
To compare price difference across venues:
Price Difference on Venue X=(Global Best Price31 Price on Venue X)/Global Best Price
Global Best Price=highest bid price across list of filtered venues, if trader order is a sell order

Global Best Price=lowest ask price across list of filtered venues, if trader order is a buy order

### Example 3

Compute Expected Balances Changes and Rank by Capital Efficiency

A trader wishes to buy 1 Bitcoin for a price of $8100—meaning that the purchase price can be $8100 or lower (Table 3). Bitcoin/USD is offered on 2 exchanges, and Bitcoin is available for a different form of capital, Ether, on a third exchange. In this example, we will use fourth exchange to compute the Ether to USD price conversion.

TABLE 3

| | Exchange A | Exchange B | Exchange C | Exchange D |
|---|---|---|---|---|
| Product/Capital | Bitcoin/USD | Bitcoin/USD | Bitcoin/Ether | Ether/ |
| Pair | | | | USD |
| Best Sell Price | $8010 | $7800 | 9.8 | $800 |
| Convert all | $8010 | $7800 | $7840 | $800 |
| Prices to USD | | | | |
| Available | USD: $8100 | USD: $12,000 | USD: $20,000 | n/a |
| balances prior to | Bitcoin: 1 | Bitcoin: 5 | Bitcoin: 2 | (ineligible |
| the new order | Ether: 24 | Ether: 2 | Ether: 30 | exchange) |
| Expected | USD: $90 | USD: $4,200** | USD: $20,000 | n/a |
| balances if the | Bitcoin: 2 | Bitcoin: 6 | Bitcoin: 3 | (ineligible |
| new order is | Ether: 24 | Ether: 2 | Ether: 20.2*** | exchange) |
| routed to the | | | | |
| venue | | | | |
| Maximum | USD: | USD: | USD: | n/a |
| Balance | abs($20,000 − | abs($20,000 − | abs($20,000 − | (ineligible |
| Differences | 90) = $19,910 | $4200) = | $8100) = | exchange) |
| between venues, | Bitcoin: abs(5 − | $15,800 | $11,900 | |
| before and after | 2) = 3 | Bitcoin: abs(6 − | Bitcoin: abs(5 − | |
| order (expected) | Ether: abs(30 − | 1) = 5 | 1) = 4 | |
| | 2) = 28 | Ether: abs(30 − | Ether: abs(24 − | |
| | | 2) = 28 | 2) = 22 | |
| Convert Balance | USD: $19,910 | USD: $15,800 | USD: $11,900 | n/a |
| Diffs to Common | Bitcoin: 3 * | Bitcoin: 5 * | Bitcoin: 4 * | (ineligible |
| form of Capital | $8000 = | $8000 = | $8000 = | exchange) |
| | $24,000 | $40,000 | $32,000 | |
| | Ether: 28 * | Ether: 28 * $800 = | Ether: 22 * $800 = | |
| | $800 = $22,400 | $22,400 | $17,600 | |
| Sum of Balance | TOTAL: | TOTAL: | TOTAL: | n/a |
| Differences | $66,310 | $78,200 | $61,500 | (ineligible |
| | | | | exchange) |
| Capital Efficiency | 2 | 3 | 1 | n/a |
| Rank (lowest | | | | (ineligible |
| difference is | | | | exchange) |
| highest rank) | | | | |

* The trader entered an order to buy at a maximum price if $8,100, but the product (Bitcoin) is available at a best price of $8010 on this venue so it will sell at that price - thus the USD dollar balance is reduced by $8010
**The trader entered an order to buy at a maximum price if $8,100, but the product (Bitcoin) is available at a best price of $7800 on this venue so it will sell at that price - thus the USD dollar balance is reduced by $7800.
***On this venue, the product (Bitcoin) will be purchase for Ether at the best price available, which is 9.8 Ether.

Expected Balances are computed as follows;
Expected Balance of Capital if order is sent to Venue X=Current Balance of Capital on Venue X−Quantity * Expected Trade Price on Venue X, if order is a buy order
Expected Balance of Product if order is sent to Venue X=Current Balance of Product on Venue X+Quantity * Expected Trade Price on Venue X, if order is a sell order
Expected Trade Price on Venue X=volume weighted price across all price/quantity levels for given product/capital pair=sum (price level * quantity likely to be traded at current price level)

Example 3A of Expected Trade Price
Order from trader is to buy 1 Bitcoin for $8100
Best price on Venue X=$8010
Quantity Available on Venue X at $8010 price level=5
Because there is sufficient quantity (5) at the best price level ($8010), the order to buy 1 Bitcoin can be completely filled at the $8010 price level so the Expected Trade Price=$8010

Example 3B of Expected Trade Price
Order from trader is to buy 1 Bitcoin for $8100
Best price on Venue X =$8010
Quantity Available at $8010 price level=0.5
Next best price on Venue X=$8020
Quantity Available at $8020 price level=2.5
Expected Trade Price=$8010*0.5+$8020*0.5=$8015

### Example 4

### Select the Optimal Venue and Form of Capital

The system will decide the optimal form of capital and the optimal venue for the order to in order to achieve the trader's goals. The trader can establish the goal as maximum capital efficiency only, maximum price benefit only, or a combination of these goals. At this point, the system has established the venue rankings for price and for capital efficiency. We can see from the results above that the venue for maximum capital efficiency (Exchange C; Table 3) is different from the venue for maximum price benefit (Exchange B; Table 2).

If the Price Priority parameter is set to 0, the trader has set of goal of capital efficiency only and the selected venue will be Exchange C and the Ether will be used as the capital to purchase the Bitcoin. If the parameter is set to 100, the trader has set a goal of price benefit only on the selected venue will be Exchange B and USD will be the form of capital.

If the Price Priority is set to a value between 0 and 100, the system will weigh the above factors to make a final venue and capital decision as follows (Table 4);

TABLE 4

| | Exchange | | | |
|---|---|---|---|---|
| | A | B | C | D |
| Product/Capital | Bitcoin/USD | Bitcoin/USD | Bitcoin/Ether | Ether/USD |
| Pair | | | | |
| Price difference | +2.69% | 0% | +0.51% | n/a |
| from best price | | | | |
| Price Difference | 0 | 1 | 1 − (0.51/2.69) = | n/a |
| Normalized (0-1)* | | | 0.81 | |
| Balance Diff | TOTAL: | TOTAL: | TOTAL: | n/a |
| Sum | $66,310 | $78,200 | $61,500 | |
| Capital | 1 − (66,310 − | 0 | 1 | n/a |
| Advantage | 61,500)/(78,200 − | | | |
| Normalized (0-1)* | 61,500) = | | | |
| | 0.72 | | | |

Normalized Price Difference on Venue X=1−(Price difference % on Venue X/Maximum price difference across all Venues)
Capital Advantage Normalized on Venue X=1−(Sum of Balance Differences on Venue X/Maximum Sum of Balance Differences across all Venues)

If the Pricing Priority is set to 50, we obtain the following result (Table 5). We see that Exchange C using Ether will be the selected.

TABLE 5

| | Exchange | | | |
|---|---|---|---|---|
| | A | B | C | D |
| Product/Capital | Bitcoin/USD | Bitcoin/USD | Bitcoin/Ether | Ether/USD |
| Pair | | | | |
| Price Difference | 0 | 1 | 0.81 | n/a |
| Normalized | | | | |
| Capital Benefit | 0.72 | 0 | 1 | n/a |
| Normalized | | | | |
| Sum, weighted | (0.5 * 0) + (0.5 * 0.72) = | (0.5 * 1) + (0.5 * 0) = | (0.5 * 0.81) + (0.5 * | n/a |
| by Price Priority | 0.36 | 0.5 | 1) = 0.905 | |

The sum weighted by priorities is calculated as;

Sum Priority=Pricing Factor/100 * Price Benefit Normalized+(100−Pricing Factor)/100 * Capital Benefit Normalized

If the Pricing Priority is set to 25, we obtain the following result (Table 6). We see that Exchange C using Ether will be the selected.

TABLE 6

| | Exchange | | | |
|---|---|---|---|---|
| | A | B | C | D |
| Product/Capital | Bitcoin/USD | Bitcoin/USD | Bitcoin/Ether | Ether/ |
| Pair | | | | USD |
| Price Difference | 0 | 1 | 0.81 | n/a |
| Normalized | | | | |
| Capital Benefit | 0.72 | 0 | 1 | n/a |
| Normalized | | | | |
| Sum, weighted | (0.25 * 0) + (0.75 * | (0.25 * 1) + (0.75 * | (0.25 * 0.81) + (0.75 * | n/a |
| by Price Priority | 0.72) = 0.54 | 0) = 0.25 | 1) = 0.9525 | |

If the Pricing Priority is set to 75, we obtain the following result (Table 7). We see that Exchange B using USD will be the selected.

TABLE 7

| | Exchange | | | |
|---|---|---|---|---|
| | A | B | C | D |
| Product/Capital | Bitcoin/USD | Bitcoin/USD | Bitcoin/Ether | Ether/ |
| Pair | | | | USD |
| Price Difference | 0 | 1 | 0.81 | n/a |
| Normalized | | | | |
| Capital Benefit | 0.72 | 0 | 1 | n/a |
| Normalized | | | | |
| Sum, weighted | (0.75 * 0) + (0.25 * | (0.75 * 1) + (0.25 * | (0.75 * 0.81) + (0.25 * | n/a |
| by Price Priority | 0.72) = 0.18 | 0) = 0.75 | 1) = 0.8575 | |

If the Pricing Priority is set to 100, we obtain the following result (Table 8). We see that Exchange B using USD will be the selected.

TABLE 8

| | Exchange | | | |
|---|---|---|---|---|
| | A | B | C | D |
| Product/Capital | Bitcoin/USD | Bitcoin/USD | Bitcoin/Ether | Ether/ |
| Pair | | | | USD |
| Price Difference | 0 | 1 | 0.81 | n/a |
| Normalized | | | | |
| Capital Benefit | 0.72 | 0 | 1 | n/a |
| Normalized | | | | |
| Sum, weighted | (1 * 0) + (0 * 0.72) = 0 | (1 * 1) + (0 * 0) = 1 | (1 * 0.81) + (0 * 1) = | n/a |
| by Price Priority | | | 0.81 | |

### Example 5

### Predicting Future Capital Balances

To predict future capital balances a predictive algorithm is used, e.g. one that uses a weighted average of previous values of the Available Balance of each type of capital, on each venue, to predict a future value of Available Balance. As an illustration, the algorithm uses the previous five Available Balance values, weighted by a time decaying factor, to compute a Trajectory of the likely change in Available Balance—for each type of capital on each exchange. These Trajectory values are added to the current Available Balance (AB) to compute the Predicted Available Balance (PAB).

### Example 6

### Buying Power (i.e. Capital Balance) Optimization Multi-Trading Venues

A trader wishes to purchase 20 Ether for 1 Bitcoin, and trader has Bitcoins buying power on two exchanges—Trading Venue A and Trading Venue B. Table 9 below shows the impact the order would have on Available Balance (buying power) at each venue.

TABLE 9

Trading Venue

| | A | B |
|---|---|---|
| Available balances prior to | USD: $8000 | USD: $2000 |
| the new order | Bitcoin: 1 | Bitcoin: 5 |
| | Ether: 24 | Ether: 2 |
| Available balances if the | USD: $8000 | USD: $2000 |
| new order is routed to the | Bitcoin: 0 | Bitcoin: 4 |
| exchange | Ether: 44 | Ether: 24 |

In this example, we can see that the resulting buying power (capital balance) is overall better if the order is routed to Trading Venue B, for 2 reasons
1.) Bitcoin Available balance is 4 if routed to Trading Venue B, but 0 if routed to Trading Venue A
2.) Ether Available balance is increased by 600% if routed by Trading Venue B, but increased by only 98% if routed to Trading Venue A
   Buying power for both Bitcoin and Ether is therefore increased to a greater degree if the order is routed to Trading Venue B instead of Trading Venue A.

### Example 7

### Incentivize Clients to Maximize Trader-Dealer Capital Efficiency

A trader wishes to buy Ether from a dealer, and pay for it with Bitcoin. The dealer is low on Bitcoin buying power (i.e. low balance of Bitcoin). The client trader will pay the dealer in Bitcoin if he accepts the quote price from the dealer—this will increase the dealer's Bitcoin buying power. Therefore, the dealer may wish to offer an attractive price to the client to incentive the client to complete the trade. The dealer may even offer a price that is better than any other venue is offering at that moment in time. The precise amount of price improvement offered by the dealer depends on how much the value the improvement in Bitcoin buying power they receive. Here again, this is an optimization problem—how much to improve the price to increase buying power. Again, an optimization algorithm and weighting scheme is used, but the inclusion of buying power as a factor is critical in trading situations where capital efficiency is crucial.

What is claimed is:

1. A computer-implemented method for managing capital efficiency in multi-venue trading in response to a trader submitting a trade order to buy or sell a product in exchange for a form of capital by:
a) calculating, in real time, available capital balances for each type of capital on each of the trading venues based on the trade order;
b) filtering a list of eligible venues based on the product specified in the trade order;
c) ranking the list of eligible venues by best to worst prices for the product specified in the trade order across all forms of capital, with all prices converted to one predetermined base form of capital;
d) computing expected changes to product and capital balances if the order were to be routed to each of the venues in the eligible list and ranking the list of eligible venues from best to worst in terms of capital efficiency;
e) selecting a venue and form of capital that optimizes capital efficiency based on predetermined parameters to use to complete the trade order.

2. The computer implemented method of claim 1, wherein venues are eligible if they have a sufficient capital balance to complete the trade order.

3. The computer implemented method of claim 1, wherein the trade order is rejected if:
no venue lists the product specified in the trade order; and/or
no venue has sufficient balance capital to complete the trade order.

4. The computer implemented method of claim 1, wherein an optimal venue and form of capital is selected based on parameters set by the trader.

5. The computer implemented method of claim 4, wherein the parameters are selected to do the following:
maximize capital efficiencies; and/or
balance capital efficiencies with price advantages.

6. The computer-implemented method of claim 1, wherein the trader selects the base form of capital and the prices of products are converted to the price in the base form of capital by means of a conversion factor in order to compare the value of the product in the different forms of capital.

7. The computer implemented method of claim 1, wherein the capital balances at each venue are rebalanced once the trade is completed.

8. The computer implemented method of claim 1, wherein, the trader sets a rebalance capital parameter to automatically rebalance the capital balances after a trade order has been completed.

9. The computer implemented method of claim 1, wherein one of the parameters used to select the venue for the trade is a pricing priority parameter.

10. The computer implemented method of claim 1, wherein the trade is automatically routed to the selected venue.

11. The computer implemented method of claim 1, wherein maximum capital efficiency is set at the point that capital balances across the traders venues are equal.

12. The computer implemented method of claim 1, wherein the maximum capital efficiency is set at a distribution of capital across the traders venues determined by the trader and/or by the algorithm.

13. The computer implemented method of claim 1, wherein the selection is made based on the capital chosen by the trader.

14. The computer implemented method of claim 1, wherein real time and/or estimated near term future capital balances are used to determine available balances and the capital efficiency is determined based on real time and/or estimated near term future capital balances.

15. A computer-readable storage device having contents adapted to cause a programmed computer system comprising one or multiple processor(s), a data storage system, at least one input device, and at least one output system, to perform operations directed to managing capital efficiency in multi-venue trading in response to a trader submitting a trade order to buy or sell a product in exchange for a form of capital, the operations comprising:
a) calculating, in real time, available capital balances for each type of capital on each of the trading venues based on the trade order;
b) filtering a list of eligible venues based on the product specified in the trade order;
c) ranking the list of eligible venues by best to worst prices for the product specified in the trade order across all forms of capital, with all prices converted to one predetermined base form of capital;
d) computing expected changes to product and capital balances if the order were to be routed to each of the venues in the eligible list and ranking the list of eligible venues from best to worst in terms of capital efficiency;
e) selecting a venue and form of capital that optimizes capital efficiency based on predetermined parameters to use to complete the trade order.

16. The computer-readable storage device of claim 15, wherein venues are eligible if they have a sufficient capital balance to complete the trade order.

17. The computer-readable storage device of claim 15, wherein the trade order is rejected if:
no venue lists the product specified in the trade order; and/or
no venue has sufficient balance capital to complete the trade order.

18. The computer-readable storage device of claim 15, wherein an optimal venue and form of capital is selected based on parameters set by the trader.

19. The computer-readable storage device of claim 18, wherein the parameters are selected to do the following:
maximize capital efficiencies; and/or
balance capital efficiencies with price advantages.

20. The computer-readable storage device of claim 15, wherein the trader selects the base form of capital and the prices of products are converted to the price in the base form of capital by means of a conversion factor in order to compare the value of the product in the different forms of capital.

21. The computer-readable storage device of claim 15, wherein the capital balances at each venue are rebalanced once the trade is completed.

22. The computer-readable storage device of claim 15 wherein, the trader sets a rebalance capital parameter to automatically rebalance the capital balances after a trade order has been completed.

23. The computer-readable storage device of claim 15, wherein one of the parameters used to select the venue for the trade is a pricing priority parameter.

24. The computer-readable storage device of claim 15, wherein the trade is automatically routed to the selected venue.

25. The computer-readable storage device of claim 15, wherein maximum capital efficiency is set at the point that capital balances across the trader's venues are equal.

26. The computer-readable storage device of claim 15, wherein the maximum capital efficiency is set at a distribution of capital across the traders venues determined by the trader and/or by the algorithm.

27. The computer-readable storage device of claim 15, wherein the selection is made based on the capital chosen by the trader.

28. The computer-readable storage device of claim 15, wherein real time and/or estimated near term future capital balances are used to determine available balances and the capital efficiency is determined based on real time and/or estimated near term future capital balances.

29. A computer-implemented method for managing capital efficiency in multi-venue trading in response to a trader submitting a trade order to buy or sell a product in exchange for a form of capital by:
a) calculating, in real time, available capital balances for each type of capital on each of the trading venues based on the trade order;
b) filtering a list of eligible venues based on the product specified in the trade order;
c) estimating future available capital balances for the types of capital on each of the trading venues;
d) selecting the type of capital to be used for completing the trade order;
e) transferring asset types between trading venues as necessary to complete the trade; and
f) routing the trading order to one or more trading venues.

30. The computer-implemented method of claim 29, wherein estimating future available capital balances is done by an algorithmic approach to estimating values in sequential numeric data.

31. The computer-implemented method of claim 30, wherein the sequential numeric data algorithm uses a weighted average of previous values of the available balances of each type of capital for the two or more trading venues.

32. The computer-implemented method of claim 31, wherein the weighted average includes a time decaying factor.

33. The computer-implemented method of claim 29, wherein the trader selects a base currency and prices of products are converted to the price in the base currency by means of a conversion factor in order to compare the value of the product in the different forms of capital.

34. The computer-implemented method of claim 33, wherein the trade order is changed to a new type of capital if the algorithm selects a different capital than the one specified in the trade order.

35. The computer-implemented method of claim 34, wherein, based on factors chosen by the trader, the cost to the trader in acquiring more of a particular type of product is calculated and compared to the best value of the product to the magnitude of price difference such that if the price advantages outweigh the capital efficiency, the trade order is sent in the type of capital that offers the greatest price advantage.

36. The computer-implemented method of claim 34, wherein, based on factors chosen by the trader, the cost to the trader in acquiring more of a particular type of product is calculated and compared to the best value of the product to the magnitude of price difference such that if the capital efficiencies outweigh the price advantages, the order is sent in the type of capital that offers the greatest capital efficiencies.

37. A computer-readable storage device having contents adapted to cause a programmed computer system comprising of one or multiple processor(s), a data storage system, at least one input device, and at least one output system, to perform operations directed to improving capital efficiency in multi-venue trading in response to a trader submitting a trade order to buy or sell a product in exchange for a form of capital, the operations comprising:
a) calculating, in real time, available capital balances for each type of capital on each of the trading venues based on the trade order;
b) filtering a list of eligible venues based on the product specified in the trade order;
c) estimating future available capital balances for the types of capital on each of the trading venues;
d) selecting the type of capital to be used for completing the trade order;
e) transferring asset types between trading venues; and
f) routing the trading order to one or more trading venues.

38. The computer-readable storage device of claim 37, wherein estimating future available capital balances is done by an algorithmic approach to estimating values in sequential numeric data.

39. The computer-implemented method of claim 38, wherein the sequential numeric data algorithm uses a weighted average of previous values of the available balances of each type of capital for the two or more trading venues.

40. The computer-implemented method of claim 39, wherein the weighted average includes a time decaying factor.

41. The computer-implemented method of claim 37, wherein the trader selects a base currency and prices of products are converted to the price in the base currency by means of a conversion factor in order to compare the value of the product in the different forms of capital.

42. The computer-implemented method of claim 41, wherein the trade order is changed to a new type of capital if the price comparison indicates a better value for the product than the type of capital initially listed on the trade order.

43. The computer-implemented method of claim 42, wherein, based on factors chosen by the trader, the cost to the trader in acquiring more of a particular type of product is calculated and compared to the best value of the product to the magnitude of price difference such that if the price advantages outweigh the capital efficiency, the trade order is sent in the type of capital that offers the greatest price advantage.

44. The computer-implemented method of claim 42, wherein, based on factors chosen by the trader, the cost to the trader in acquiring more of a particular type of product is calculated and compared to the best value of the product to the magnitude of price difference such that if the capital efficiencies outweigh the price advantages, the order is sent in the type of capital that offers the greatest capital efficiencies.
